(19) United States
(12) Patent Application Publication
(10) Pub. No.: US 2019/0367118 A1
(43) Pub. Date: Dec. 5, 2019

(54) TWO-TIERED STRUCTURAL FRAME FOR A THREE-WHEELED CARGO BIKE

(71) Applicant: Juggernaut Cargo, Inc., Denver, CO (US)

(72) Inventor: Jeffrey MAUCK, Denver, CO (US)

(21) Appl. No.: 16/478,252

(22) PCT Filed: Jan. 19, 2018
(86) PCT No.: PCT/US18/14403

§ 371 Date: Jul. 16, 2019

Related U.S. Application Data
(60) Provisional application No. 62/448,837, filed on Jan. 20, 2017.

(51) Int. Cl. B62K 5/05; B60G 3/06; B62K 5/06; B62J 7/06; B62K 21/02; B62K 25/04; B62K 15/00

(52) U.S. Cl. CPC B62K 5/05; B60G 3/06; B62K 5/06; B62J 7/06; B60G 2300/122; B62K 25/04; B62K 15/00; B60G 2200/144; B60G 2200/44; B62K 21/02

(57) ABSTRACT

Embodiments of the present invention include to a two-tier structural frame for a three-wheeled cargo bike. The structural frame can be the platform for the entire bike and includes both steering and suspension parts. The frame of the bike and its related suspension and steering parts provide stability, durability, and comfort, while in motion under human pedal power, as well as motion from a hybrid of human pedal and electric-assisted power sources.

### CROSS REFERENCE TO RELATED APPLICATIONS

This application claims priority and benefit under 35 U.S.C. § 119(e) to U.S. Provisional Patent Application Ser. No. 62/448,837, filed on Jan. 20, 2017, which is incorporated herein in its entirety by reference. This application is related to the Taiwanese Patent Application No. 107102134, which is incorporated by reference in its entirety.

### FIELD OF INVENTION

The invention is related to a two-tier structural frame for a three-wheeled cargo bike. The structural frame is intended to be the platform for the entire bike and is related to steering and suspension parts.

### BACKGROUND

Cargo bikes have been around for decades in many parts of the world. The United States currently does not have an American cargo bike company that designs and manufactures a three-wheeled bike with the cargo in the front of the bike for the American market.

Cargo bikes exist in American factories for carrying tools. These are cargo “trikes” where the materials are carried in the back of the bike. Other cargo bikes in the United States are designed and constructed by hobbyist and do not take into consideration function, safety, and efficient or smooth travel.

These and other issues presented by current designs can be addressed with the present invention.

### SUMMARY

The present invention is designed to meet the needs of people living in cities in the United States, and around the world. One aspect of the invention is directed to a three-wheeled bike that is stable, safe, and easy to turn. Other considerations in the design and implementation of the invention are the economics and ease of production. The present invention can be mass-produced for consumers in North America, and beyond.

A majority of American cities sprawl out greater distances and are less compact than most cities around the world. An benefit of the present invention is that it can be used to travel long distances, at greater speeds than prior art designs, and still be narrow enough to fit in a one-way bike lane. The present invention can be used to travel comfortably over paved or unpaved surfaces while maintaining structural stability, in part because of the two-tiered design.

The frame of embodiments of the present invention can absorb and distribute forces during straight-line travel and while turning. The two-tiered frame allows the suspension system to operate correctly and offer the bike its functionality & durability qualities. The a-arms and kingpin of the invention enable the wheels to spin into the direction of a turn and not slip or skip sideways when traveling around a curve. The rod and plate steering mechanisms of the invention assure firm anchorage to the kingpin, which holds the axles and wheels/tires. The shocks on each side of the frame control vibratory motion and offer resistance in the form of unwanted bounce and keep the tires planted on the ground. The a-arms link both sides of the bike on the top and bottom of the frame rail. The a-arms can be a hinged suspension linkage. These elements can be any suitable shape. In some embodiments, the a-arms can be u-shaped and include two or more pinned connections at each end. The purpose of the a-arm is to link the kingpin the frame, the suspension and the axle that carries the wheel. A-arms interconnect the shocks to the top tube and the bottom tube of the frame. The lower a-arm connects the bottom of the shock at the piston mount, while the cleats for the to the fixed top shock mount are linked (directly or indirectly) to the top frame rail.

The design of the suspension, frame, and steering mechanism is based on their close relationship to one another, which was established by exploration of the Ackermann equation for use in a cargo bike. The present invention is believed to be the first front wheel design cargo bike with Ackermann steering and a suspension system.

In the Ackermann equation, the geometry is validated only when the wheels and axles are organized as radii of circles with a common central point in a turned position. The rear wheel of the present invention is fixed, while the front wheels are not fixed and can turn. From this fixed point (at the rear axle) a line is drawn. Then two lines are drawn from each of the front axles back to a central point from the rear axle. In a computer model, the equation is proven when all circles drawn can be traced to a common point. A successful “real world” result happens when the outside wheel is positioned at a greater angle (β) (i.e., between about 90° and about 180°, or in some embodiments between about 105° and about 120° than the angle for the inside wheel (α), while turning, with relation to Ackermann point as illustrated when the wheels are turning right as illustrated in FIG. 2. One skilled in the art would understand a similar relationship when the wheels are turning left, where the outside wheel would be at an angle (i.e. between about 0° and 90°, in some embodiments between about 15° and about 30°) that is less than the angle of the inside wheel.

Angled wheel positioning and the incorporation of shocks create a system that works to keep the operator safely positioned on the vehicle and counter balance the forces going into a turn. In an embodiment of the present invention, the top and bottom a-arms on the cargo bike can be vertically offset between about 0.75 inches and about 1.5 inches, and in some embodiments about one inch, when viewed from the top down. This offset helps achieve a steep angle on the kingpin. The kingpin has at least one bolted attachment at the top center and the bottom center of each a-arm. The bottom of the kingpin is angled outward further toward the front of the bike than the top. This configuration provides faster steering with less effort required to steer the cargo bike. This relationship between the top and bottom a-arms works in the same manner as the head tube and fork to facilitate the steering of a standard two-wheel bicycle.

Further, this configuration and positioning works to provide a design that assist wheels/tires to angle from tire patch to top of tire and firmly, plant the wheels/tires on the road surface while cornering, thus allowing the bike to steer without having the tires skidding and slipping during the turn.

The arrangement of the suspension components and the sizing of each are dependent on the bike's overall frame width, as well as the kingpin on center-to-center width.

The two-tiered frame is an integral part of the success of this offset between the top and bottom a-arms. The bottom and top tubes are mathematically positioned to be spaced apart the height of the kingpin. A-arms are bolted to water-jet-cut plain-steel cleats, which are adhered to the bike with welds or other joining methods.

It is another aspect of the present invention to provide a two-tiered frame design having two levels of frame structure with one frame positioned over the other. The on-center locations (i.e. the location at about the middle of the a-arm in relation to the height oh the bike) of the top and bottom tubes are dictated by the length the kingpin. In some embodiments, center tubes connect the front and back of the bike. The two-tiered frame in the front extends to the seat post via the center top and bottom frame tubes where the rider is positioned. In one embodiment, angled vertical supports tie the top and bottom frames together. In another embodiment, each side only has one angled vertical support because the front of the frame is curved and the top tube curves down to interconnect with the bottom tube.

It is one aspect of the present invention to provide an aesthetically pleasing design. There are two aesthetic qualities of the frame design. First, the side supports in the front of the bike are the same angle as the seat post. Second, the look of the frame is carried from the front of the bike to the back of the bike for a homogeneous look.

Another aspect of the present invention is a platform that offers the user flexibility regarding the use of the platform. Specifically, the occupant basket is not required to be a permanent part of the overall structure, which means an occupant basket can be incorporated for people or items people may want to carry or the occupant basket can be removed entirely. The two-tiered frame provides the ability to manufacture the occupant basket from a variety of materials including, but not limited to, steel, aluminum, wood, titanium, other metal, composite, carbon fiber, or polycarbonate. The strength of the two-tiered frame allows for any configuration of basket to be fastened to the frame, without the need for the basket to be overdesigned. Thus, an occupant basket only needs to have enough strength for itself and its occupants. Additionally, the rest of the bike does not rely on the basket for strength. Thus, a basket can be a lighter weight material (e.g. composite, plastic, etc.).

Additionally, the two-tiered frame design can be used without the basket in a flatbed mode for carrying cargo. Thus, the frame itself can be used for transport as a flatbed with a sheathing over the frame. The frame can be covered in steel, aluminum, wood, titanium, or polycarbonate to take on the utility of a traditional flatbed truck. Accordingly, the user can carry cargo as high or heavy as he/she can safely maneuver.

One aspect of the invention is to provide a bike that is stable. This bike stability is accomplished by having a frame that is low to the ground and, therefore, has a low center of gravity. Additionally, the material of the bike frame can be steel (or other metal) where the overall weight is on the bottom of the bike.

It is another aspect of embodiments of the present invention to provide a frame with an improved rear triangle. The rear triangle interconnects the seat post to the rear wheel/tire. Thus, the seat post completes the rear triangle, which is capable of housing two types of tires. The bike according to embodiments of the present invention can have a street-oriented tire that is thin and smooth, much like a traditional road bike tire. Alternatively, the rear triangle can accommodate a mountain bike tire or snow tire, which is thicker and rougher than the street-oriented tire.

In some embodiments, the width of the rear triangle of the bike can accommodate a rear hub for an e-assist system (i.e. an electric motor to propel one or more wheels of the bike). Also, dropouts, one or more tabs, typically made of metal, on the drive side of the bike near where the rear wheel is anchored in the frame, are adjustable and remove any tension in the belt drive system. In order to add tension to the drive belt, an adjustable drop out allows the rear wheel to be slid or pivoted into place then fastened. By moving the wheel away from the crank set, chain tension is increased on the dropout by hand turning the tensioner.

It is another aspect of embodiments of the present invention to provide a bike with side-mounted suspension. An advantage of the two-tiered design is that the suspension is mounted on the side of the bike. The a-arm suspension can be attached (e.g. bolted) onto cleats that are attached to the top and bottom rails/tubes of the frame, which allows the frame to be lower to the ground and flatter in turns than prior art designs. This system is in stark contrast to the tilting or leaning cargo bike offerings from Butchers & Bikes (as described in WO2015067760) or Veleon systems. Additionally, the side mounted suspension keeps the frame lower to the ground, which keeps the occupants and cargo flatter and more stable throughout turns and curves. The side suspension also flattens the travel for the of center of bike relative to the height of the bike.

In one embodiment, on the bottom of the bike, located directly under the frame, is the steering mechanism, which is a proprietary design consisting of steel rods attached to stainless steel water-jet-cut parts.

In one embodiment, a method of assembly process is provided comprising: milling steel; placing the steel in a jig for a front of a bike; performing tack attachments; completing the attachment; removing the bike from the jig; milling and forming steel into a rear triangle for the bike; place the rear triangle in the jig; performing tack attachments on the rear triangle; incorporating drop outs; completing the attachments on the rear triangle; removing the rear triangle from the jig; placing the front of the bike in the jig; placing the back of the bike in a second jig; tack attaching a top tube and a bottom tube to the front and back of the bike; remove the bike from the jigs; and attaching the center structural tube to the bike. The order depicted in these steps can be altered without deviating from the invention. For example, the steps can be in reverse, or a section of the bike can be manufactured then joined to the remaining portions of the bike. The attachments can be by welding, gluing, brazing, soldering, and other fusion processes that create a sufficient amount of strength to permanently join the materials. In some embodiments, the attachment method can be welding.

In another embodiment, a method of assembling a cargo bike frame is provided comprising: placing steel tubes for a front of the bike onto a cutting bed of a laser cutter; cutting both ends of each steel tube, wherein the cut is a straight cut or a miter cut; bending each tube into a desired shape to form a top tube and a bottom tube; placing the shaped tubes onto a jig; placing internal sleeves on selected butt joints; performing tack attachments on joints & joined parts; completing the attachments; removing the bike from the jig; milling and forming steel into a rear triangle; placing the rear triangle in the jig; performing tack attachments on joints & joined parts; incorporating drop outs; completing the attachments; removing the rear triangle from the jig; placing the front of the bike and a back of the bike into the jig; tack attachments the top tube to the front and back of the bike; tack attachments the bottom tube to the front and back of the bike; removing the bike from the jig; attachments the center structural tube to the bike. The order depicted in these steps can be altered without deviating from the invention. For example, the steps can be in reverse, or a section of the bike can be manufactured then joined to the remaining portions of the bike. The attachments can be by welding, gluing, brazing, soldering, and other fusion processes that create a sufficient amount of strength to permanently join the materials. In some embodiments, the attachment method can be welding.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification and claims are to be understood as being modified in all instances by the term “about”.

The term “a” or “an” entity, as used herein, refers to one or more of that entity. As such, the terms “a” (or “an”), “one or more,” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. Section 112(f). Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

These and other advantages will be apparent from the disclosure of the invention(s) contained herein. The above-described embodiments, objectives, and configurations are neither complete nor exhaustive. The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

### BRIEF DESCRIPTION OF DRAWINGS

Those of skill in the art will recognize that the following description is merely illustrative of the principles of the invention, which may be applied in various ways to provide many different alternative embodiments. This description is made for illustrating the general principles of the teachings of this invention and is not meant to limit the inventive concepts disclosed herein.

The accompanying drawings, which are incorporated in and constitute a part of the specification, illustrate embodiments of the invention and together with the general description of the invention given above and the detailed description of the drawings given below, serve to explain the principles of the invention.

FIG. 1 is side view of a frame according to embodiments of the present invention;

FIG. 2 illustrates a top view for a three-wheeled vehicle illustrating how the steering axes meet at one point in an embodiment of the invention;

FIG. 3 illustrates an axonometric view of the suspension with top and bottom a-arms and kingpin in an embodiment of the invention;

FIG. 4 illustrates a bottom view of vehicle looking upward at steering components in an embodiment of the invention;

FIG. 5 illustrates a front view of vehicle in an embodiment of the invention;

FIG. 6 illustrates a side view of suspension to illustrate camber;

FIG. 7 illustrates an inside rear view of the kingpin;

FIG. 8 illustrates the inside front view of the kingpin;

FIG. 9 illustrates a bike with cargo storage;

FIG. 10 is a perspective view of a frame according to one embodiment of the present invention;

FIG. 11 is a perspective view of a frame of the cargo area according to a second embodiment of the present invention; and

FIG. 12 illustrates an embodiment of the invention with the bike and the cargo storage.

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. It is to be understood that the phraseology and terminology used herein is for the purpose of description and should not be regarded as limiting.

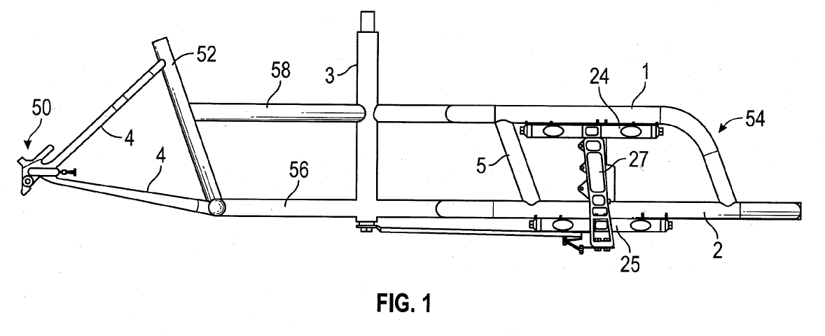

FIG. 1 is a side view of the bike frame with different diameter tubing. In the embodiment shown, the bike frame comprises large tubing 1, 2, 5, 56, 58 and small tubing 4. The large tubing can all be the same size or may vary in diameter. For example, some of the large tubing 1, 2, 5, 56, 58 can be one diameter while the other large tubing 1, 2, 5, 56, 58 can be another diameter. In some embodiments, the steering column tube 3 can be the same diameter as the large diameter tubing 1, 2, 5, 56, 58; while in other embodiments, the steering column tube 3 can be a different diameter. In one embodiment, the diameter of the large tubing 1, 2, 5, 56, 58 can be between about 1.00 inch and about 2.00 inches. In a preferred embodiment, at least some of the large tubing 1, 2, 5, 56, 58 can have a diameter that is about 1.50 inches. In one embodiment, the thickness of the large diameter tubing 1, 2, 5, 56, 58 is between about 0.25 inches and about 0.50 inches. In a preferred embodiment, the thickness of the large diameter tubing 1, 2, 5, 56, 58 can be about 0.35 inches. In one embodiment, the steering tube 3 has a diameter between about 1.50 inches and about 2.00 inches. In a preferred embodiment, the steering tube 3 has a diameter of about 1.73 inches. In one embodiment, the thickness of the steering tube 3 is between about 0.25 inches and about 0.5 inches. In a preferred embodiment, the thickness of the steering tube 3 is about 0.35 inches.

Some of the large diameter tubing 1, 2, 5 supports the cargo area 54. The top tubing 1 and bottom tubing 2 of the frame are interconnected (for example, welded in one embodiment) on one end to the steering column tube 3. On the front end of the bike frame, the top tubing 1 curves downward and interconnects to the bottom tubing 2. The tubing 56, 58 behind the steering column 3 terminate and are interconnected (for example, welded in one embodiment) to the seat post 52. In the embodiment shown, the tubing 56, 58 behind the steering column 3 are large diameter tubing. Both tubing 56, 58 can be the same diameter or can be different diameters. For example, the lower tubing 56 can have a larger diameter than the upper tubing 58.

The smaller diameter tubing 4 forms the rear triangle and is interconnected (for example, welded in one embodiment) to the seat post 52. There are multiple tubes 4 on the rear triangle, but only two are visible in this view. Each tube 4 can be the same diameter and thickness, or different diameters and thicknesses. The diameter of the rear triangle tubes 4 can be fitted to receive a standard bike tire. In some embodiments, a 27.5 inch bike tire can be adapted to be received by the rear triangle. The rear triangle tubes 4 can terminate in an adjustable dropout 50 for receiving a bike tire. Any sized bike tire could be used in various embodiments. The bike tire can be a road tire, a mountain tire, or a snow tire, for example.

In some embodiments, a frame mounted electric assist motor can be accommodated at the bottom bracket area. This would be located at the end of the seat tube 52 where it meets with the bottom tube 56 and both lower armatures of the lower rear triangle 4.

In some embodiments, the seat tubing 52 can be the industrial standard for the seat tubing to allow for seats to be inserted into the seat tube 52. A seat pin can be used, which can be based on industrial standards which can allow quick adjustments of the seat height and angle of the seat to the frame.

The material for the bike frame or any component of the bike can be metal, by way of example, aluminum, titanium, steel, alloys thereof or combinations thereof, or a composite material. Materials for some components, for example the kingpin, the diamond plate and the triangle plate, can be chosen based on the likelihood of damage caused by oxidation. For example, components that are likely to be scratched and exposed to elements can be made from materials such as stainless steel to provide added resistance to oxidation. Additionally, coatings can be added to the components to resist oxidation. Other components that are less likely to be exposed to oxidation can be made of materials that are susceptible to oxidation because the likelihood of such an exposure is low. For example, the shock cleats or a-arm cleat can be made from a plain steel instead of a stainless steel. Some components can be made of aluminum parts, for example suspension components. However, one skilled in the art would understand that the suspension parts can be made from other materials without deviating from the invention. One skilled in the art would also understand that the method used to attach the parts to each other will depend upon the material being used. For example, an epoxy or glue can be used to join composite materials or metal and composite materials, where a weld, solder, or braze can be used to join metal materials. Mechanical attachments can also be used, for example with bolts, etc. As an added measure of strength between the top tube 1 and bottom tube 2, an angle tube 5 can be interconnected (in some embodiments, it is welded) to the top tube 1 and the bottom tube 2. The angle between the angle support tube 5 and the bottom tube 2 can be between about 50° and about 130°. In one embodiment, there are at least two angled support tubes 5 on each side of the bike. In another embodiment, there is only one angled support tube 5 on each side of the bike. In some embodiments, no angled support tube 5 can be used.

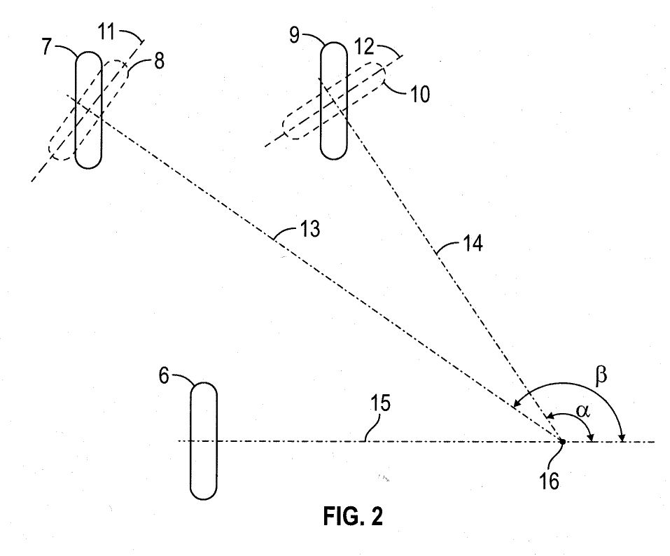

FIG. 2 illustrates a top view diagram of a three-wheeled vehicle according to an embodiment of the present invention. The two front wheels are illustrated in a straight position 7, 9 and a turned position 8, 10. The rear wheel 6 remains stationary or pointing straight (i.e. parallel to straight position 7, 9 of the front two wheels). The dashed lines 13, 14, 15 meet at one central point 16. FIG. 2 also illustrates the Ackermann steering diagram because the front wheels in the straight position 7 and 9 become wheel positions 8 and 10 when turning. While the turned wheeled position 8, 10 are illustrated turning to the right, one skilled in the art would understand that the wheels could be turned to the left without deviating from the invention.

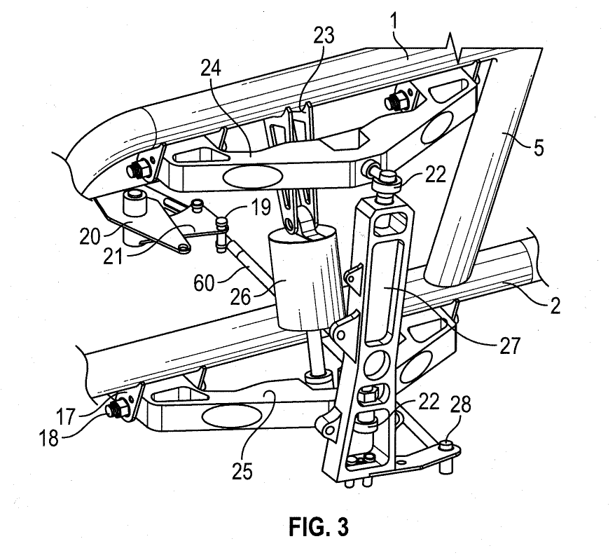

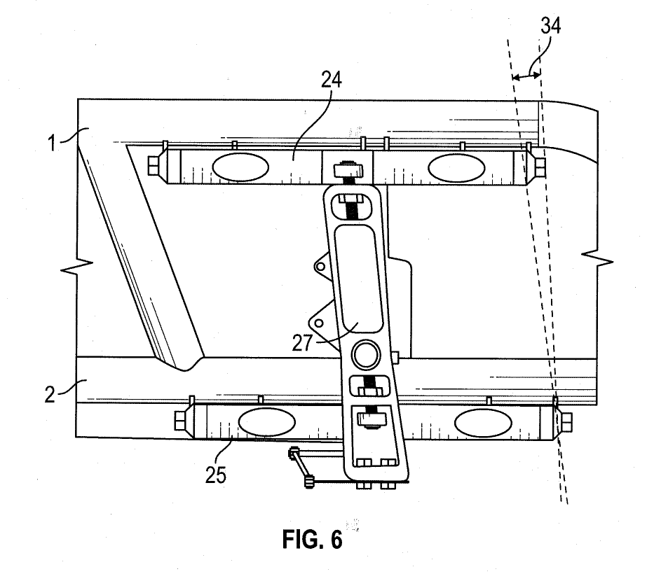

As the vehicle is moved into a turned position, the center of wheel positions 8 and 10 are represented as dashed centerlines 11 and 12 and are perpendicular to dashed lines 13 and 14, which intersect at the center point 16. Once the dashed lines 13 and 14 intersect at center point 16, the wheels/tires will lean in the direction of a caster angle provided in the slant of the kingpin 34 (illustrated in FIG. 6). When this occurs, a one-inch offset in the upper a-arms 24 (illustrated in FIG. 3) and lower a-arms 25 (illustrated in FIG. 3) comes into play, keeping the wheel firmly planted and the vehicle turning in its intended direction. The rear wheel 6 will lean into the direction of the turn and the shock 26 (illustrated in FIG. 3) can dampen the reactive forces by transferring some of the forces into the frame top tube 1 (illustrated in FIG. 1).

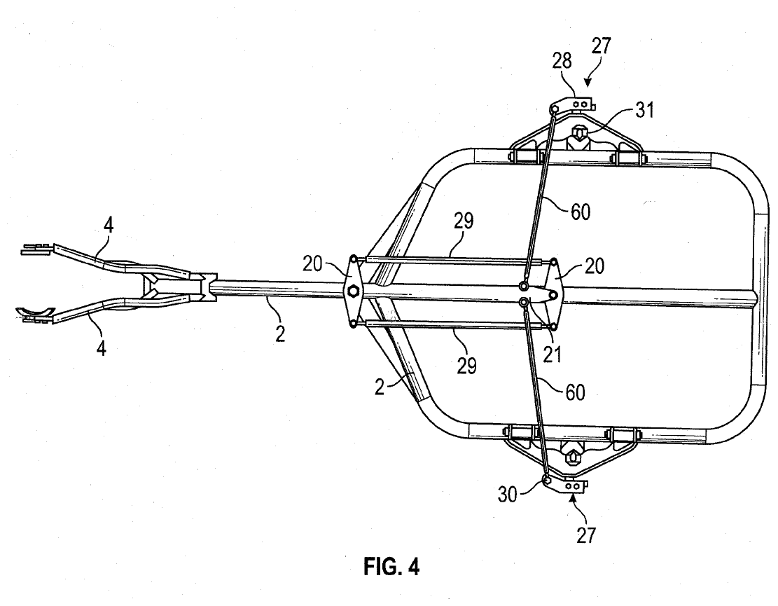

FIG. 3 illustrates the axonometric relationship between the shock 26, a-arms 24, 25, kingpin 27, and steering tie rods 29 (shown in FIG. 4). The a-arm bolted connections 18 are interconnected (for example, welded or bolted) to the underside of top tube 1 of the frame and to the underside of the bottom tube 2. The a-arm 25 is connected to the bottom tube 2 with a-arm cleat 17.

In some embodiments, the top tube 1 can have a thicker sidewall than the bottom tube 2 because the top tube 1 must be capable of resisting bending forces from shock 26, as these forces are transferred to the top tube 1. The cleats 23 are interconnected or welded directly to the bottom of the top tube 1. The cleats 23 are also centered between the bolted a-arm connections 18.

The shock cleats 23, which can be water jet cut, are interconnected or welded to the underside of the top frame tube 1, centrally located (within about plus or minus 5% from the center point) relative to the upper a-arm 24. The bottom shock connection is centrally located (within about plus or minus 5% from the center point) relative to the center bottom of a-arm 25 and is fastened with, by way of example, a bolt and lock nut. During rotational movement, the shock 26 moves with the lower a-arm 25 to dampen vibrational forces, hence providing a more comfortable and controlled ride for the operator.

The multidirectional super-swivel ball joints 22, are bolted to the top and bottom of the kingpin 27. The super-swivel ball joints 22 allow the wheel/tire to turn in the fore and aft direction, which allow turning from right to left.

Turning the handle bars mounted at the steering tube 3 (illustrated in FIG. 1) controls steering. The diamond plate 20, and triangular plate 21 (which can be made of a metal like stainless steel, aluminum, titanium, alloys thereof, or the like) underneath the vehicle are connected or bolted with fasteners 19 to steering rods coming from the steering tube 3 (illustrated in FIG. 1), as well as rods that attach the plate 21 to the kingpin 27. One skilled in the art would understand that the general shape of the diamond plate 20 and triangular plate 21 can vary without deviating from the invention. The kingpin connection plate 28 (which can be made from a metal such as stainless steel, aluminum, titanium, alloys thereof, or the like) is attached to the bottom of the kingpin 27. This attachment allows the vehicle to be steered.

FIG. 4 is a bottom view of the bike frame and illustrates the relationship of the steering components and the kingpin 27 according to one embodiment of the present invention. Two diamond plates 20 interconnect to the bottom of the center bottom tube 2 and one diamond plate 20 (the one on the left) interconnects to the bottom of the steering column 3 (illustrated in FIG. 1). The diamond plates 20 can be the same size or the sizes can vary. Two rods 60 interconnect to the diamond plate 20 and are positioned directly between the kingpins 27 and in the middle (±about 10%) of the vehicle. The triangular plate 21 is bolted or interconnected to and works in conjunction with the diamond plate 20 under the approximate center of the vehicle and the steering tube 3. A shock 26 (shown in FIG. 3) is bolted or interconnected to the bottom of a-arm 31. Rods 60 (which can be solid or hollow) are then bolted or interconnected with a fastener 30 to the kingpin-rod attachment plate 28, located at the bottom of the kingpin 27. This configuration allows the vehicle to turn from right to left. The top tubing 1 is not visible in FIG. 2 because the top tubing 1 and the bottom tubing 2 are in the same plane. It is possible to offset the bottom tube 2 and the top tube 1 so that the bottom tube 2 is slightly inward (i.e. between about 0.125 inches and about 0.75 inches difference between the centerline of the top tube 1 and the bottom tube 2). Offsetting the top tube 1 and bottom tube 2 will result in a smaller turning radius for the bike.

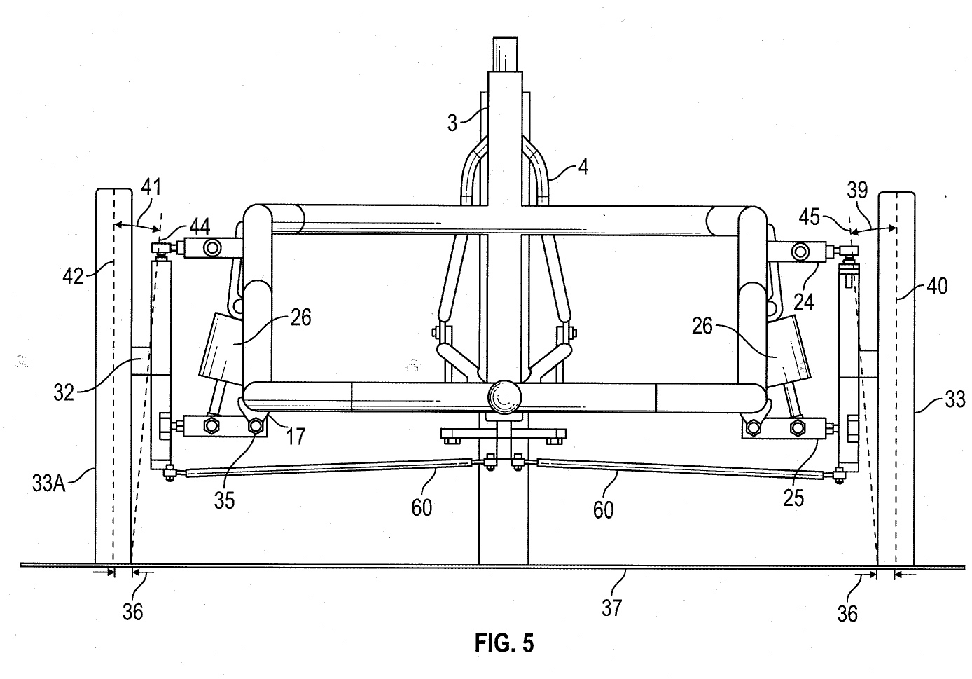

FIG. 5 illustrates a front view of the vehicle according to an embodiment of the invention. The front view is at an angle of the wheel relative to vertical, as viewed from the front or the rear. The left side steering axis 44 and the center of the left wheel 42 intersect on the ground plane 37. Wheel movement occurs when the wheel 33A at the centerline 42 engages with the surface 37 (i.e., when the axel 32 is approximately perpendicular with the wheel 33A). Three points are made to operate in a triangular sequence: axis 44, true wheel center 42, and the ground plane 37 all intersect. Movement can also occur when the wheel 33A is at an angle 41 so that the centerline 42 approaches line 44 and contacts the surface 37 near the edge of the wheel 33A. Conversely, on the right side of the vehicle, angle 39, center wheel position 40, and the ground plane 37 all intersect and work to balance the left side of the vehicle. Ideally the angles 39, 41 of the center at the bottom of each wheel are the same. When all conditions are met on both sides of the vehicle, then the camber is achieved. In one embodiment, angles 39 and 41 are between about 1° and about 45°. In a preferred embodiment, angles 39 and 41 are between about 10° and about 35°. In a more preferred embodiment, angles 39 and 41 are between about 10° and about 25°. At about 0°,the movement of the bike would be straight and not turning.

The shock 26 is mounted to lower a-arm 25, with the connector 35. In one embodiment, the camber 36 offset is provided by between about 0.75 inches and about 1.5 inches. In a preferred embodiment, the camber 36 offset is provided by about a one-inch offset. The camber 36 is dictated by both the movement of the swivel joint 22 and the a-arms 25, 24 during vehicle travel over uneven surfaces and throughout the duration of a turn. FIG. 6 is a side view of the suspension used to better illustrate the caster offset 34.

The caster offset 34 is between about 0.75 inches and about 1.5 inches, in one embodiments. In a preferred embodiment, the caster offset 34 is about 1 inch. FIG. 6 also illustrates an embodiment where the camber angle is positive. In other words, the top of the kingpin pivot point is pulled back from the bottom of the kingpin pivot point. The positive caster angle increases stability of the bike compared to negative camber angles, which can be advantageous, especially at high speeds and can increase tire lean while cornering. The caster offset 34 is due to the location the kingpin 27 is interconnected to the top tube 1 relative to the bottom tube 2.

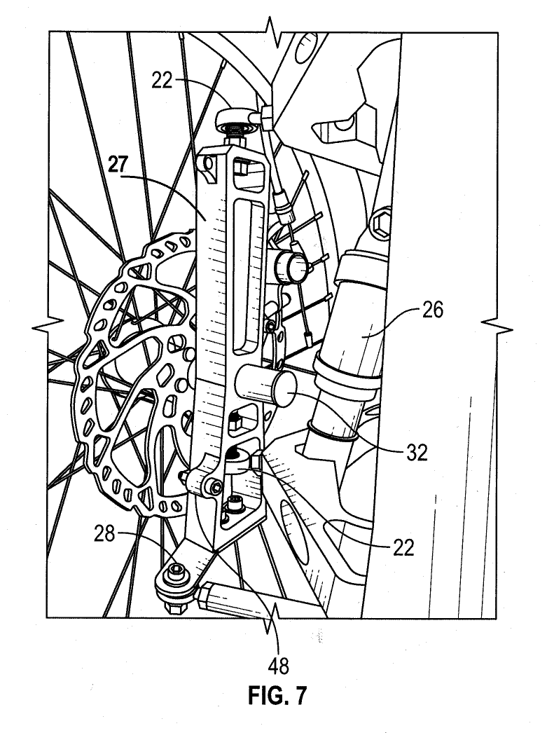

FIG. 7 is an illustration of the kingpin 27 and illustrates the many functions of this component. The connection plate 28 is located below the kingpin 27. A wheel stop 48 prevents the tire from turning into the frame. The wheel stop 48 can be centrally located near the lower super-swivel ball joint 22. Above super-swivel ball joint 22 is the axle 32 in which hub and brake are positioned. Finally, at the top of FIG. 7 is the upper super-swivel ball joint 22, which was also illustrated in FIG. 3.

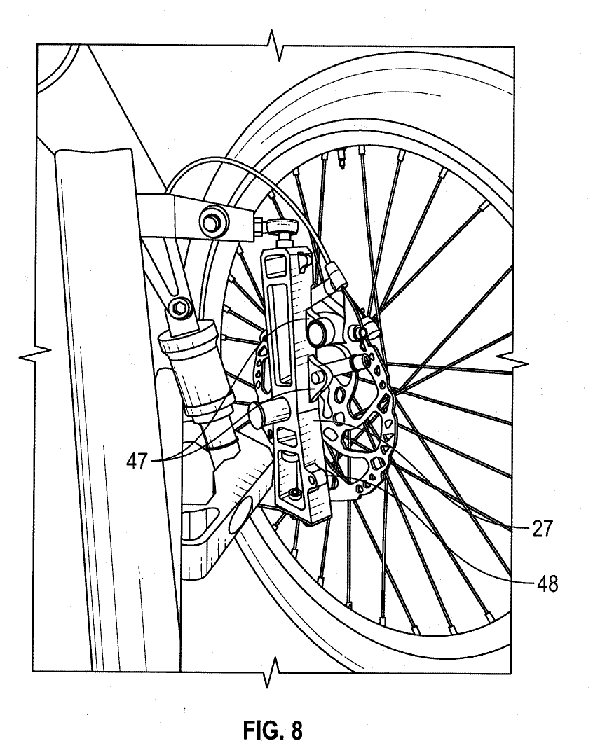

In FIG. 8, the inside front view of the kingpin 27 illustrates the brake mount 47. Note that the bottom mount on the outside of edge of the kingpin 27, directly across from the a-arm 25, can be left unused because the kingpin design is universal. Meaning a single design of the kingpin 27 can be used on both sides of the bike by flipping the component in the opposite direction. The wheel stop 48 can be located between the kingpin 27 and the wheel. The brake mounts 47 can be located on the kingpin 27.

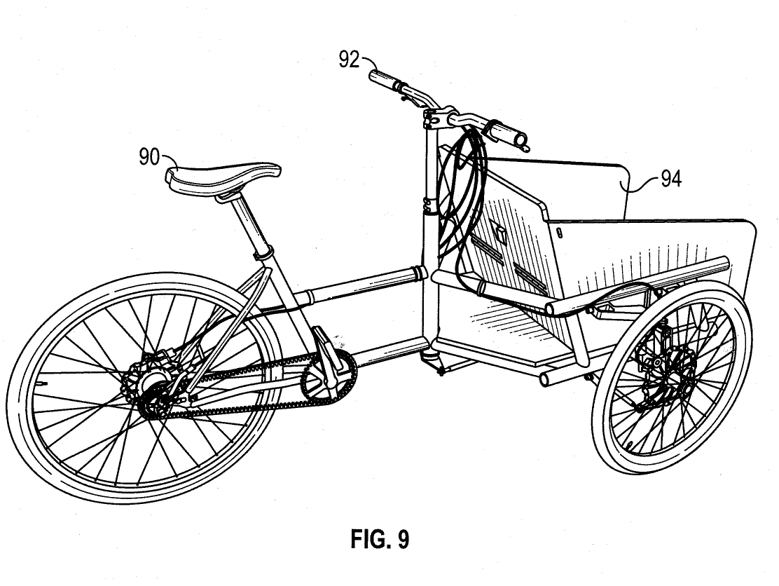

FIG. 9 illustrates one embodiment of the bike with a cargo storage 94 attached to the front of the bike. The bike further includes a seat 90, that can be any suitable seat. The bike also includes handle bars 92, which can be straight bars or shaped handle bars. In some embodiments, the handle bars 92 can be wider than a standard handle bar to allow for more control of the bike. FIG. 9 illustrates the brakes of the bike being controlled by brake devices on the handle bar 92, though one skilled in the art would understand that the brakes can be controlled by the pedals without deviating from the invention. The cargo storage 94 can be any suitable shape to fit the cargo space of the bike. The cargo storage 94 can be made of wood, metal, composite, plastic, polycarbonate, combinations thereof, or any other material known in the art. The cargo storage 94 can be any size to fit into the area provided by the frame of the bike. In some embodiments, more than one cargo storage unit can be utilized. Furthermore, the carbo storage unit can be removable, which can allow for easy storage, transport and shipping. The cargo storage 94 can be adapted to provide seating for one or more passengers. The cargo storage 94 can be enclosed or open. The wheels of the bike can be the same size or can be different, and can be standard sized or custom made.

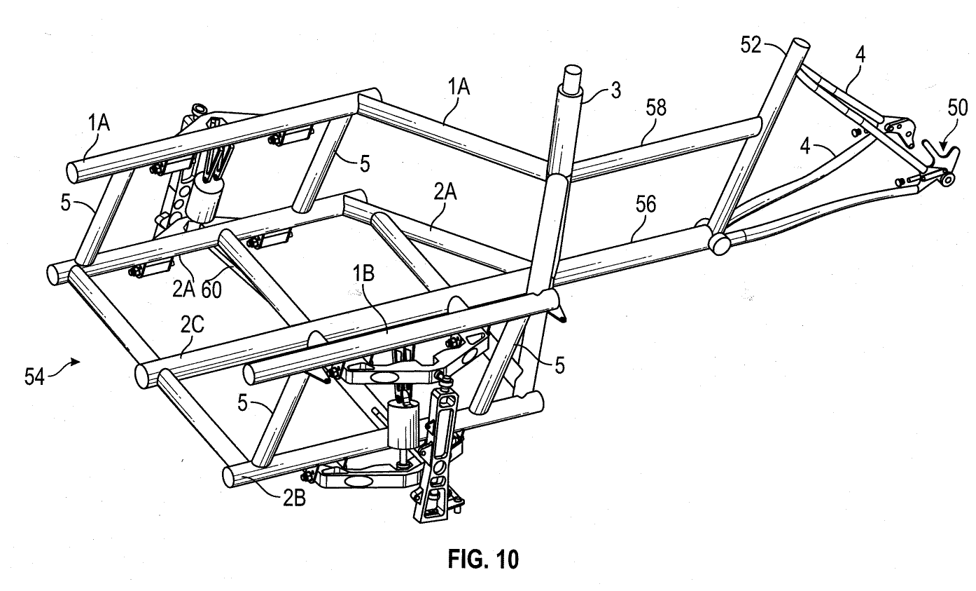

FIG. 10 is a perspective view of the frame of the bike according to one embodiment of the present invention. The cargo area 54 is in the front of the bike. The frame can be adapted to provide collapsibility, reducing the overall width and volume so that the bike can be easier to store, transport, or ship. The frame includes right upper tubes 1A, left upper tubes 1B, right lower tubes 2A, left lower tubes 2B, and a center lower tube 2C. The frame also includes angled support tubes 5, a steering column tube 3, and tubing 56, 58 behind the steering column tube 3. Behind the tubes 56, 58 is the seat tube 52, and behind the seat tube 52 are the rear triangle tubes 4, which terminate in an adjustable dropout 50 for receiving a bike tire.

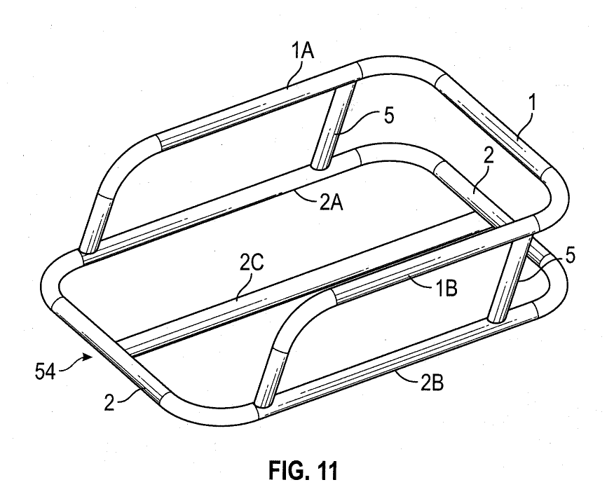

FIG. 11 is a perspective view of a frame of the cargo area according to a second embodiment of the present invention. Here, the frame tubing is bent to interconnect the top tubes 1A, 1B to the bottom tubes 2A, 2B. The cargo area 54 is in the front of the frame. The frame includes a right upper tube 1A, a left upper tube 1B, an upper rear tube 1, a right lower tube 2A, a left lower tube 2B, a center lower tube 2C, a lower rear tube 2, and angled support tubes 5.

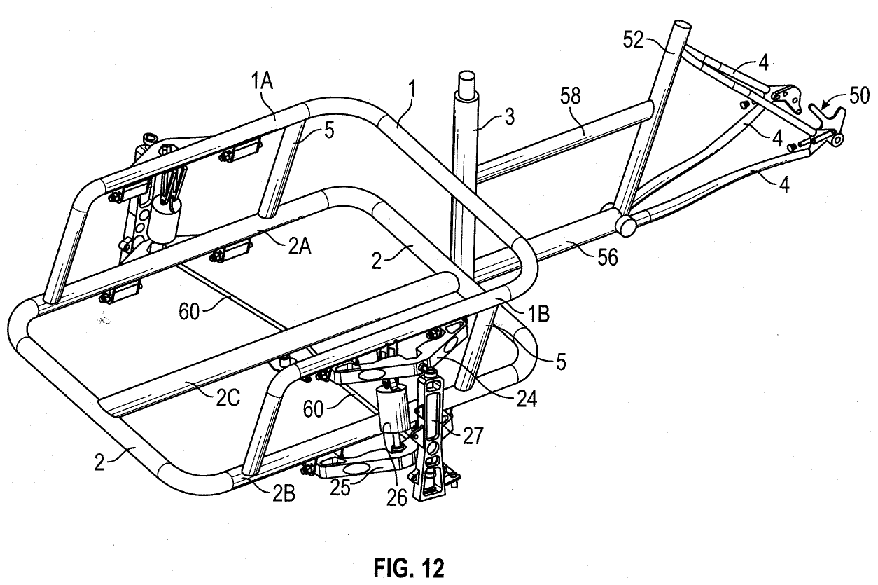

FIG. 12 is a perspective view of the front cargo framing for the bike according to an embodiment of invention with a tube forming method. FIG. 12 includes elements that are similar to the elements described in FIG. 10. But the configuration of the cargo frame in FIG. 12 is slight different in that it incorporates the cargo area as described in FIG. 11. Thus, the frame tubing is bent to interconnect the top tubes 1A, 1B to the bottom tubes 2A, 2B. bending the frame as illustrated in FIG. 11 decreases the number of attachments required during manufacturing, which can result in fewer failure points and reduction of production costs. The frame can be adapted to provide collapsibility, reducing the overall width and volume so that the bike can be easier to store, transport, or ship. The frame also includes angled support tubes 5, a steering column tube 3, and tubing 56, 58 behind the steering column tube 3. Behind the tubes 56, 58 is the seat tube 52, and behind the seat tube 52 are the rear triangle tubes 4, which terminate in an adjustable dropout 50 for receiving a bike tire.

The frame as described herein is illustrated in several pieces. However, the frame could be made of a single piece without deviating from the invention. Furthermore, in some embodiments, it is advantageous for the frame to be made of multiple pieces, so that the bike can be disassembled or be made collapsible allowing for ease of storage of the bike and further allowing the bike to become compact when not in use.

Ranges have been discussed and used within the forgoing description. One skilled in the art would understand that any sub-range within the stated range would be suitable, as would any number within the broad range, without deviating from the invention.

Accordingly, the present invention has been described with some degree of particularity directed to the exemplary embodiments of the present invention. It should be appreciated though that modifications or changes may be made to the exemplary embodiments of the present invention without departing from the inventive concepts contained herein.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiment described hereinabove is further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

1. A two-tiered vehicle frame, comprising:
a top tube;
a bottom tube;
steering post, wherein the top tube and the bottom tube extend from the front of the frame to the steering post;
at least one rear tube;
a seat post, wherein the at least one rear tube connects the steering post to the seat post;
rear triangle, wherein the rear triangle attaches to the seat post;
a cargo storage area located between a first side of the frame and a second side of the frame; and
steering system comprising:
a first top a-arm, wherein the first top a-arm is located on the top tube;
a first bottom a-arm, wherein the first bottom a-arm is located on the bottom tube;
a second top a-arm, wherein the second top a-arm is located on the top tube at a location across from the first top a-arm;
a second bottom a-arm, wherein the first bottom a-arm is located on the bottom tube at a location across from the first bottom a-arm;
a first kingpin, wherein the first kingpin attaches between the first top a-arm and the first bottom a-arm; and
a second kingpin, wherein the second kingpin attaches between the second top a-arm and the second bottom a-arm.

2. The frame of claim 1, wherein a material for at least one of the top tube, the bottom tube, the steering post, the at least one rear tube, the seat post, the rear triangle, the first top a-arm, the first bottom a-arm, the second bottom a-arm, the second bottom a-arm, the first kingpin, or the second kingpin is selected from the group consisting of aluminum, titanium, steel, an alloys thereof, a composite material and combinations thereof.

3. The frame of claim 1, wherein the steering system further comprises:
a triangle plate;
a first rod, wherein the first rod connects the first kingpin to the triangle plate;
a second rod, wherein the second rod connects the second kingpin to the triangle plate;
a first diamond plate, wherein the first diamond plate connects to the triangle plate;
at least one tie rod;
a second diamond plate, wherein the second diamond plate connects to the first diamond plate with at least one tie rod, and wherein the second diamond plate connects to the steering post.

4. The frame of claim 1, further comprising at least one support tube.

5. The frame of claim 1, wherein the top tube and the bottom tube are in the same vertical plane.

6. The frame of claim 1, wherein the bottom tube and the top tube are not in the same plane, and wherein the bottom tube is inward by between about 0.125 inches and about 0.75 inches from a centerline of the top tube and a centerline of the bottom tube.

7. A bike, comprising:
a forward end;
a rear end;
a first forward wheel proximate the forward end, wherein the first forward wheel can turn right and left;
a second forward wheel proximate the forward end, wherein the second forward wheel can turn right and left;
a rear wheel proximate the rear end, wherein the rear wheel is fixed and cannot turn;
a frame comprising:
an upper right tube proximate the forward end of the bike;
an upper left tube proximate the forward end of the bike;
an upper tube positioned between and interconnected to the upper right tube and the upper left tube;
a lower right tube proximate the forward end of the bike;
a lower left tube proximate the forward end of the bike;
a lower tube positioned between and interconnected to the upper right tube and the upper left tube;
a steering column positioned behind the upper tube and the lower tube;
a rear tube interconnected to the steering column and extending rearward;
a seat post interconnected to the rear tube; and
a rear triangle comprising two or more small tubes and extending rearward from the seat post, wherein the rear wheel is interconnected to the rear triangle;
a first kingpin interconnected to the upper right tube and the upper left tube, wherein the first kingpin is interconnected to the first forward wheel; and
a second kingpin interconnected to the upper right tube and the upper left tube, wherein the second kingpin is interconnected to the second forward wheel.

8. The bike of claim 7, wherein the first and second kingpins permit the first and second forward wheels to turn at different angles at the same time when the bike is turning.

9. The bike of claim 7, wherein the first kingpin is interconnected to a first upper a-arm on an upper end of the first kingpin and the first upper a-arm is interconnected to the upper right tube, and wherein the first kingpin is interconnected to a first lower a-arm on a lower end of the first kingpin and the first lower a-arm is interconnected to the lower right tube.

10. The bike of claim 9, wherein the second kingpin is interconnected to a second upper a-arm on an upper end of the second kingpin and the second upper a-arm is interconnected to the upper left tube, and wherein the second kingpin is interconnected to a second lower a-arm on a lower end of the second kingpin and the second lower a-arm is interconnected to the lower left tube.

11. The bike of claim 9, wherein the first upper a-arm is horizontally offset from the first lower a-arm a distance of approximately 1.0 inch, such that the first upper a-arm is positioned slightly in front of the first lower a-arm.

12. The bike of claim 7, further comprising:
a triangle plate;
a first rod, wherein the first rod connects the first kingpin to the triangle plate;
a second rod, wherein the second rod connects the second kingpin to the triangle plate;
a first diamond plate, wherein the first diamond plate connects to the triangle plate;
at least one tie rod; and
a second diamond plate, wherein the second diamond plate connects to the first diamond plate with at least one tie rod, and wherein the second diamond plate connects to the steering post.

13. The bike of claim 7, wherein a material for at least one of the upper right tube, the upper left tube, the lower right tube, the lower left tube, the upper tube, and the lower tube is selected from the group consisting of aluminum, titanium, steel, an alloy thereof, a composite material, and combinations thereof.

14. The bike of claim 7, further comprising a cargo area proximate the forward end, wherein the cargo area has an open front end and a closed rear end.

15. The bike of claim 7, wherein when the bike is turning and the first forward wheel is an inside wheel in a turn, the first forward wheel turns at a greater angle than the second forward wheel, which is an outside wheel in the turn, such that neither wheel slips in a turn.

16. The bike of claim 14, wherein the first and second forward wheels lean in a direction of a caster angle provided in a slant of the first and second kingpins.

17. A method of making a vehicle, comprising:
milling and forming steel;
placing the formed steel in a jig;
tack attaching the milled and formed steel;
completing an attachment between a first top tube and a first bottom tube to produce a front of the vehicle;
removing the front of the vehicle from the jig;
milling and forming steel into a rear triangle for the vehicle;
place the rear triangle in the jig;
performing tack attachments on the rear triangle;
incorporating drop outs;
completing the tack attachments on the rear triangle;
removing the rear triangle from the jig;
placing the front of the vehicle in the jig;
placing the back of the vehicle in a second jig;
tack attaching a second top tube and a second bottom tube to the front and back of the vehicle;
remove the vehicle from the jigs;
attaching a center structural tube to the vehicle; and
attaching three wheels to the vehicle.

18. The method of claim 17, wherein the tack attaching is selected from the group consisting of welding, gluing, brazing, soldering, and combinations thereof.

19. The method of claim 17, further comprising:
forming a steering column;
attaching the steering column to the first top tube and the first bottom tube;
forming a seat post;
attaching the seat post to the rear triangle, the second top tube, and the second bottom tube.

20. The method of claim 19, further comprising:
forming a handle bar;
attaching the handle bar to the steering column, wherein the handle bar can rotate around the steering column.
